(19) United States
(12) Patent Application Publication
(10) Pub. No.: US 2002/0194015 A1
(43) Pub. Date: Dec. 19, 2002

(54) Distributed database clustering using asynchronous transactional replication

(75) Inventors: Raz Gordon, Hadera (IL); Eyal Aharon, St. Tlvon (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Incepto Ltd.

(21) Appl. No.: 10/155,197

(22) Filed: May 28, 2002

Related U.S. Application Data
(60) Provisional application No. 60/293,548, filed on May 29, 2001.
(60) Provisional application No. 60/333,517, filed on Nov. 28, 2001.

(51) Int. Cl. G06F 17/60

(52) U.S. Cl. 705/1

(57) ABSTRACT

A method for enabling a distributed database clustering that utilizes asynchronous transactional replication, thereby ensuring high availability of databases, while maintaining data and transaction consistency, integrity and durability. The method is based on the following primary innovative techniques: Database Grid technique for generating multiple copies of database version transactions on a plurality of servers in a cluster; and a Cluster Commit technique for maintaining transaction durability. In addition, a master election component is operated, for continually deciding which cluster server is active.

This application claims priority from application number 60/293,548, filed May 29, 2001 and application number 60/333,517, filed Nov. 28, 2001, both by the same inventors.

### FIELD AND BACKGROUND OF THE INVENTION

1. Field of the Invention

The present invention relates to a distributed database clustering method, and in particular, executing the above using asynchronous transactional replication.

2. Description of the Related Art

As information technology increasingly becomes a way to integrate enterprises; a number of trends are reshaping how businesses look at computing resources. An integrated enterprise puts enormous demands on an information system. In this climate, it has become clear that a high-end Enterprise Computing system must be: scalable, to handle unexpected processing demands; available, to provide access to employees, customers and suppliers around the globe 24 hours a day; secure, particularly as more and more business is done over public networks; open, in order to integrate information from multiple sources; flexible, to run a variety of workloads while maintaining service levels; and cost effective.

The heart of the information system is the database system, and the search for greater efficiency in database processing has led to many alternative database configurations that aim to provide higher availability, greater scalability, faster processing, greater security etc. One of the primary existing database high availability solutions is database clustering. Database clustering refers to the use of two or more servers (sometimes referred to as nodes) that work together, and are typically linked together in order to handle variable workloads or to provide continued operation in the event that a failure occurs. A database cluster typically provides fault tolerance (high availability), which enables the cluster servers to enable continued operation of the cluster in the event that one or more servers fails. In addition, any database cluster is required to retain ACID properties. ACID properties are the basic properties of a database transaction: Atomicity, Consistency, Isolation, and Durability.

Atomicity requires that the entire sequence of actions must be either completed or aborted. The transaction cannot be partially successful.

Consistency requires that the transaction takes the resources from one consistent state to another.

Isolation requires that the transaction's effect is not visible to other transactions until the transaction is committed.

Durability requires that the changes made by the committed transaction are permanent and must survive system failure.

Existing database clustering solutions fall into the following categories:

1) Shared storage clusters: All cluster database servers are attached to a common storage device (may be a physical disk, SAN storage device, or any other storage system). The database is stored on this shared storage and used by all database servers.

The main deficiency of shared storage database clusters is that the shared storage is a single point of failure. The common approach of protecting the shared storage is by using storage redundancy technologies such as RAID. Although this provides increased reliability compared to a single disk, it still has a single point of failure (e.g. the RAID controller), and usually cannot protect a computer system against disasters, since all storage devices reside at the same location.

2) Storage replication solutions: Duplications of the database are stored on all participating storage servers, which may be located at multiple locations to provide disaster protection. Changes to the database are copied, synchronously (i.e. waiting for all other servers to implement the change) or asynchronously (with no such wait), from the server on which the change took place to the other servers in the group. It should be noted that storage replication by itself only entails duplication of the storage, and in order to provide a high availability solution, some clustering technology is required.

In the case of synchronous replication, completion of a commit operation (which refers to the saving of a transaction in non-volatile memory so that it is durable) requires a typical synchronous storage replication system to store a new transaction on some or all its sub-devices, in a manner that guarantees the redundancy. In the case of multiple-location redundant storage devices, this method typically requires an expensive, high-speed, low-latency and usually private communication infrastructure, which does not allow the locations to be too far apart, as this would create unacceptable latency. An appropriate communication infrastructure needs to be redundant by itself further raising the price. Single location solutions do not solve the single point of failure as a disaster may destroy the entire site, including the entire redundant storage device.

In the case of asynchronous replication, typical solutions do not enable database high-availability since they do not provide guaranteed durability of committed database transactions (i.e. they may lose committed database transactions upon failure). Following is a simple example that demonstrates this: let A be the storage server on which a transaction is committed and B be another storage server. Server A processes a client-requested transaction, commits it to its local storage device, and returns an acknowledgement to the client that considers the information as durable in the database (i.e. under no circumstances will the data get lost). The replication engine puts the transaction in a transmission queue, waiting to be sent to server B. Suppose that server A fails at this point in time (after the transaction is locally committed at server A but before it was sent to B). The database at server B does not include the transaction. In such a case either the database cannot be accessed (i.e. no high-availability) or the database continues to be served by B, causing the transaction to be lost. Recovering such a transaction later requires manual intervention. For these reasons, storage replication solutions that use asynchronous replication are not typically suitable for high availability database systems, because they do not provide transaction durability.

3) Transactional replication solutions: Duplicates of a database are stored on all participating servers. Any transaction committed to an active server is copied, synchronously (i.e. waiting for all other servers to commit the transaction to their local databases) or asynchronously (with no such wait), from the database server on which the transaction was committed to the other participating servers, at the level of the database server (as opposed to at the storage level). It should likewise be noted that transactional replication by itself only entails duplications of the transactions, and in order to provide a high availability solution, some clustering technology is required. In principal, transactional replication solutions share the same limitations of their storage replication counterparts (see above): synchronous transactional replication suffers from inherent latency and performance problems that grow as the database servers are more distant from each other. Asynchronous transactional replication may result in losses of committed transactions and therefore, by itself, is not suitable for high availability database systems, because it does not guarantee transaction durability.

Currently available database cluster configurations, while aiming to provide high availability, typically comprise one or more of the following limitations: a single point of failure; no guaranteed transaction durability; no ability to automatically recover from subsequent failures; and an inherent performance degradation of the database server that increases as the distance between cluster servers grows.

Following is a summary of the capabilities of the various existing technologies:

| | Shared-disk | Synchronous replication | | Asynchronous replication | |
|---|---|---|---|---|---|
| Function | clustering | Storage | Trans. | Storage | Trans. |
| Single point of failure | Yes | No | No | No | No |
| Guaranteed data | Yes | Yes | Yes | No | No |
| consistency | | | | | |
| Compliance with | Yes | Yes | Yes | No | No |
| ACID properties | | | | | |
| Automatic recovery | Yes | Yes | Yes | No | No |
| from subsequent | | | | | |
| failures | | | | | |
| Inherent performance | No | Yes | Yes | No | No |
| degradation | | | | | |
| Price range | Medium | High | High | Low | Low |
| Applicability for | Yes¹ | Yes² | Yes² | No³ | No³ |
| database clustering | | | | | |
| Product examples⁴ | Microsoft Cluster | EMC GeoSpan | Oracle DataGuard | Veritas volume | In all major |
| | Server | | | replicator | RDBMS |
| | Oracle Real | | | CA SurviveIt | |
| | Application | | | Legato Co- | |
| | Clusters | | | Standby Server | |
| | IBM Parallel | | | | |
| | SysPlex | | | | |
| Notes: | | | | | |
| ¹With the exception of a single point of failure. | | | | | |
| ²To minimize performance degradation, expensive equipment and communications infrastructure are required. | | | | | |
| ³No compliance with ACID rules. | | | | | |
| ⁴The product examples referred to are fully incorporated herein by reference, as if fully set forth herein: Microsoft (Microsoft Corporation, Redmond, WA, www.microsoft.com); Oracle Corporation, Redwood Shores, CA, www.oracle.com); IBM (International Business Machines Corporation, Armonk, NY, www.ibm.com); EMC (EMC Corporation, Hopkinton, MA, www.emc.com); Veritas (Veritas Software Corp., Mountain View, CA, www.veritas.com); | | | | | |
| # Legato (Legato Systems, Inc., Mountain View, CA, www.legato.com) | | | | | |

U.S. Pat. No. 5,956,489, of San Andres, et al., which is fully incorporated herein by reference, as if fully set forth herein, describes a transaction replication system and method for supporting replicated transaction-based services. This service receives update transactions from individual application servers, and forwards the update transactions for processing to all application servers that run the same service application, thereby enabling each application server to maintain a replicated copy of service content data. Upon receiving an update transaction, the application servers perform the specified update, and asynchronously report back to the transaction replication service on the “success” or “failure” of the transaction. When inconsistent transaction results are reported by different application servers, the transaction replication service uses a voting scheme to decide which application servers are to be deemed “consistent,” and takes inconsistent application servers off-line for maintenance. Each update transaction replicated by the transaction replication service is stored in a transaction log. When a new application server is brought on-line, previously dispatched update transactions stored in the transaction log are dispatched in sequence to the new server to bring the new server's content data up-to-date. The '489 invention's purpose is to maintain an array of synchronized servers. It is targeted at content distribution and does not provide high availability. The essence of this invention is the distribution service that acts as a synchronization point for the entire array of servers. As such, however, it must be a single service (one to many relation between the service and the array servers), which makes it a single point of failure. Therefore, the entire system described in the patent cannot be considered a high availability system.

U.S. Pat. No. 6,014,669, of Slaughter, et al., which is fully incorporated herein by reference, as if fully set forth herein, describes a highly available distributed cluster configuration database. This invention includes a distributed configuration database wherein a consistent copy of the configuration database is maintained on each active node of the cluster. Each node in the cluster maintains its own copy of the configuration database, and configuration database operations can be performed from any node. The consistency of each individual copy of the configuration database can be verified from the consistency record. Additionally, the cluster configuration database uses a two-phase commit protocol to guarantee that the copies of the configuration database are consistent among the nodes. This invention, although not a replication technology per se, shares the deficiencies of category 3 above (synchronous transactional replication), and likewise suffers from inherent latency and performance problems that grow as the database servers are more distant from each other. The global locking mechanism of the '669 patent implements single writer/multiple reader and therefore is conceptually identical to synchronous storage replication, in that it stalls the entire database cluster operation until the writer completes the write operation.

The above products usually present only partial solutions to database high availability needs. These often expose the user to risks of downtime and even lost transactions and critical data. There is thus a widely recognized need for, and it would be highly advantageous to have, an integrated approach that ensures high availability of databases, while maintaining data and transaction consistency, integrity and durability. There is also a need for such an approach to provide disaster tolerance, by spanning the cluster over distant geographical locations. Without all these elements, critical databases are vulnerable to unacceptable downtime, loss of data and/or degraded performance.

### SUMMARY OF THE INVENTION

According to the present invention there is a method for enabling a distributed database clustering system, posing no limitation on the distance between cluster nodes while inducing no inherent performance degradation of the database server, that can enable high availability of databases, while maintaining data and transaction consistency, integrity, durability and fault tolerance. This is achieved by utilizing, as a building block, asynchronous transactional replication.

A database server cluster is a group of database servers behaving as a single database server from the point of view of clients outside the group. The cluster servers are coordinated and provide continuous backup for each other, creating a fault-tolerant server from the client's perspective.

The present invention provides technology for creating distributed database clusters. This technology is based on three main modules: Master Election, Database Grid and Cluster Commit. Master Election continuously monitors the cluster and selects the active server. Database Grid is responsible for asynchronously replicating any changes to the database of the active server to the other servers in the clusters. Since this replication is asynchronous it suffers from the same problems that make asynchronous replication inadequate for clustering databases (mentioned in section 2 above). Cluster Commit overcomes these limitations and ensures durability of cluster-committed transactions in the cluster. I.e. no recoverable failure of individual servers in the cluster, or of the entire cluster, will destroy cluster-committed transactions. In addition, as long as the cluster is operational, the state of the database, as exposed by the cluster as a whole, will be identical to the state of the database after the committing of all these transactions.

It is important to note that the active database server in a cluster may continue processing transactions normally (additional transactions from additional applications), while the cluster commit operation is in progress. During this entire process, normal database performance is maintained. In this way, the advantages of both synchronous and asynchronous transactions are maintained, providing data processing efficiency and transaction durability.

### BRIEF DESCRIPTION OF THE DRAWINGS

The principles and operation of a method according to the present invention may be better understood with reference to the drawings, and the following description it being understood that these drawings are given for illustrative purposes only and are not meant to be limiting, wherein:

FIG. 1 is an illustration of the architecture of a distributed database grid, according to the present invention.

FIG. 2 is an illustration of the initial setup of the Cluster Commit software.

FIG. 3 is an illustration of the CoIP software (which is an example of an implementation of the present invention) creating copies of the installed databases.

FIG. 4 is an illustration of the CoIP software maintaining the databases continuously synchronized.

FIG. 5 is an illustration of the CoIP software executing fail-over to server B upon failure in server A.

FIG. 6 is an illustration of the CoIP software executing recovery from the server A failure.

FIG. 7 is an illustration of the CoIP software executing resumption of normal operation.

### DESCRIPTION OF THE PREFERRED EMBODIMENT

The present invention relates to a method for enabling distributed database clustering that provides high availability of database resources, while maintaining data and transaction consistency, integrity, durability and fault tolerance, with no single point of failure, no limitations of distance between cluster servers, and no inherent degradation of database server performance.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention provides a method for creating database clusters using asynchronous transactional replication as the building block for propagating database updates in a cluster. The essence of the present invention is to add guaranteed durability to such an asynchronous data distribution setup. The present invention therefore results in a database cluster that combines the advantages of synchronous and asynchronous replication systems, while eliminating their respective deficiencies. Such a database cluster is therefore superior to database clusters configured on top of either single-location or multiple-location (distributed) storage systems.

According to the present invention, a plurality of servers is grouped together to form a database cluster. Such a cluster is comprised of a group of computers interconnected by network connections only that share no other resources. According to the present invention, there are no restrictions on the type of the network used. However, the network must have a “backbone”, which is a point or segment of the network to which all cluster nodes are connected, and through which they converse with each other. No alternative routes, which bypass the backbone, may exist. The backbone itself needs to be fault-tolerant as it would otherwise be a single point of failure of the distributed cluster. This backbone redundancy may be achieved using networking equipment supporting well-known redundancy standards such as IEEE 802.1D (spanning tree protocol). There is no restriction on the distance between the cluster computers. In order to allow proper operation and avoid network congestions, the network bandwidth between any pair of cluster computers should be able to accommodate data transfers required by the asynchronous replication scheme, described below.

Each server within the database cluster exchanges messages periodically with each other server. These messages are configured to carry data such as the up-to-date status of a server and the server's local primary database version (DB(k,k) for server k, as defined in the following section. In this way, all cluster servers are aware of each other's existence (absence is detected by the fact that messages are not received from the server), status and database version.

The technology of the present invention achieves its functional goals by combining three primary techniques:

1. A Database Grid technique for generating and maintaining multiple copies of the database on a plurality of servers in a cluster.

2. A Cluster Commit technique for maintaining transaction durability.

3. A master election component for dynamically deciding which of the cluster nodes is the active node (the node which is in charge of processing update transactions).

Database Grid (DG) Technique

Any technique for enabling generating and maintaining of multiple copies of a database on a plurality of servers in a cluster, using asynchronous transactional replication as a building block, may be used. An example of such a technique, which continuously performs the above, is as follows:

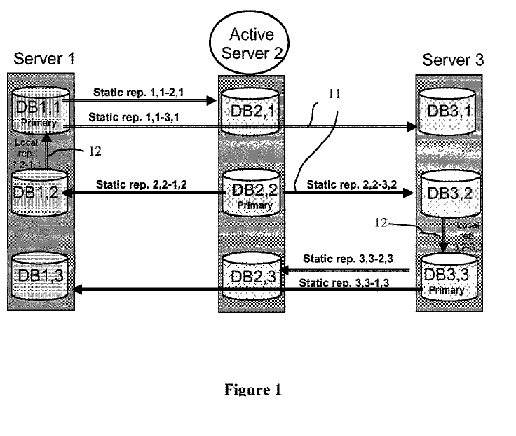

Let N be the number of servers in a cluster, indexed from 1 to N. DG starts with a single database that needs to be clustered. The database should reside on one of the cluster servers, which may be referred to as the “Origin” server. As can be seen in FIG. 1: Let this be server 1. Let the database be DB(1,1).

DG duplicates the database, creating an N by N matrix of databases DB(1 . . . N, 1 . . . N) that are exact copies of the original database. DB(k, 1) . . . DB(k, N) [DB(1,1) . . . DB(1,3) in FIG. 1 ] are local to server k [server 1], for each 1<=k<=N. DB(k,k) [DB(1,1) in the Figure] is the local primary database of server k—the database into which transactions are applied when k becomes the active server of the cluster. Modification transactions are not allowed into the database during the duplication process (this holds for any DG technique being used).

DG then creates a set of one-way asynchronous replication links between the various databases residing on the different servers in the cluster, in order to allow changes in the “active” database (see below) to propagate to all of the matrix databases. The replication links are illustrated by the arrow lines in the Figure. There are two types of replication links: “static” and “local”.

Static replications are represented in the Figure by horizontal lines 11 connecting primary databases to other (replica) databases. These static replications are of the form DB(k,k) →DB(j,k), where 1<=k,j <=N and k≠j. I.e. This process entails replication of the primary database of server k to any other replica databases in the cluster (a replica database is maintained for every primary database, on each server in the cluster). Static replications are active at all times.

Local replications are represented in the Figure by vertical lines 12 connecting replica databases to primary databases on each server in the cluster. These local replications are of the form DB(k,a)→DB(k,k)[DB(1,2) . . . DB(1,1) in FIG. 1], where a is the index of the active cluster server. Local replications are deployed on any server k, where k≠a. Local replications are added and removed to accurately reflect this rule whenever the active cluster server is changed. Notice that DB(k,a) is in-sync (synchronized) with DB(a,a)[DB(2,2) in the Figure] since the static replication DB(a,a) →DB(k,a) is always in-place (DB(k,a) is the replica of the active server's primary database on the inactive server k). However, when building a local replication DB(k,a) →DB(k,k) on-the-fly, transactions that have been added recently to DB(k,a) may not exist in DB(k,k). Therefore, a synchronization of databases prior to the activation of the local replication is required. This synchronization makes DB(k,k) identical to DB(k,a). In order to perform this synchronization with no race problems when updating the database, the DB(a,a)→DB(k,a) static replication may be suspended for the duration of the synchronization. It should be resumed after the local replication is activated. This causes all pending transactions (that were applied to DB(a,a) while the replication was suspended) to be copied through the replication pipes.

Cluster Commit Technique

The Database Grid technology creates asynchronous replication paths for ensuring that transactions, committed to the active database DB(a,a), will eventually be replicated to all databases in the grid. However, DG alone does not guarantee that committed transactions will survive a failure (the transaction durability property is not preserved), as replication takes place after the transaction is committed in the active server. Any failure between the commit time to the active server (as of before the failure) and the time the transaction is fully replicated to the server that becomes active after the failure will cause the transaction to be lost. Moreover, it is easy to see that the dynamic creation of local replications will cause this transaction to be effectively rolled back as all databases in the grid are synchronized to reflect the content of the active server's database, which does not contain the transaction.

Clearly, the above scenario would have been a violation of the Durability requirement, specified in the ACID properties. The cluster commit technology provides a solution for this problem.

Cluster Commit is an element that clearly distinguishes the present invention from all other known high availability solutions based on asynchronous replication. Cluster Commit, in contrast to other known technologies, guarantees durability of committed transactions in the cluster. Due to the strict requirement for full ACID compliance set by all database systems, this capability makes the present invention the only high availability solution based on asynchronous replication suitable for use with database systems.

Successful Cluster Commit (CC) ensures that all transactions, locally committed to the active server prior to the execution of the cluster commit operation, are durable in the cluster. I.e. no recoverable failure of any of servers in the cluster, or of the entire cluster, will destroy these transactions. In addition, as long as the cluster is operational, the state of the database, as exposed by the cluster as a whole, will be identical to the state of the database after all of these transactions have been committed.

The Cluster Commit technology comprises several mechanisms:

1. Availability monitor: this mechanism is executed on the active server (the server on which transactions are currently being executed), and continuously updates a list of ‘Available Servers’. An Available Server is a functional cluster server (i.e. has no error conditions) that responds ‘quickly enough’ to database version updating (see below). Specifically, the monitor scans active servers that are “Unavailable” for their version number, and puts them back into an “Available” state whenever this version number matches the version number of the Active Server.

2. Cluster Commit operation (database versioning): a special table, used exclusively by the cluster commit mechanism, is added to the origin database before the database grid is constructed (a similar table is added to all the databases that are later added to the cluster). This table stores the database version number. The Cluster Commit operation performs a transaction that increments this version number on the active server. The active server then waits for this transaction to be committed at all Available Servers (each target server responds with a special message whenever a new version number is detected in the special table of its local primary database—which is the database that receives application commands when it is running on the active server). Since transactional replication is a first-in-first-out mechanism, the commit of this transaction to the remote server's primary database ensures that all previous transactions (transactions committed prior to the database version transaction) are committed to the remote server's primary database as well. Any of the Available Servers not responding ‘quickly enough’ are marked as “Unavailable”, removing it from the list of servers that the cluster commit operation waits for. The operation is successfully completed when all Available Servers have responded.

It is important to note that the active database server may continue processing transactions normally (additional transactions from additional applications), while the cluster commit operation is in progress. During this entire process, normal database performance is maintained.

3. Cold-Start state: this state is a local state for any of the servers in a cluster. It is entered whenever a cluster server suffers a failure that does not allow the particular server to continue receiving database updates from other servers in the cluster. Examples of such failures are server failures, server shutdowns or server disconnections (from the backbone) etc. When the server recovers after such a failure, it enters a ‘cold start’ state, in which it needs to collect more information for deciding which server should be the active cluster server. If there is a current active server, the cold-starting server resumes normal operation immediately. This is necessary in order to avoid the potential damage of selecting a server with a database version that is not up-to-date.

In order to exit a cold-start state, a server must:

a. receive a periodic message from the active cluster server.

b. If no active server exists (e.g. when all other cluster servers are in cold-start), the server waits to receive messages from all cluster servers, in order to conclude which has the latest database version. The one having the latest database version is elected as the candidate to be the active server.

Master Election Component

The master election component determines, on a continuous basis, which cluster server is the active server candidate (the server that should be the active server), based, among other parameters, on the database version of the primary database of the server. When the candidate is different from the actual (current) active server, a fail-over process takes place, wherein the active node, when realizing that it is not the candidate, relinquishes its active state. When the candidate recognizes that no active node exists in the cluster, the candidate executes a take-over procedure, thereby making itself the active node.

The algorithm of this component, which is used to determine the above, is arbitrary and not directly related to the present invention. However, the algorithm must comply with the following constraints:

1. A node with an error condition preventing it from communicating with the backbone is never selected to be the active node candidate.

2. An unavailable node is never selected to be the active node candidate.

3. A cold-starting node is not selected to be the active node candidate unless all other cluster nodes are in cold start state and the node has the latest version of the database.

A preferred embodiment of the present invention utilizes the above-described mechanisms to provide high-availability for databases, even when hardware, software or communication problems of some predefined degree happen. This embodiment is provided in the form of software for building distributed database clusters. The clustering software is installed on each database server participating in the cluster. At the user's command, a database is added to the cluster. This causes the Database Grid for this database to be established. When this is done, an active server is elected and the database is continuously available to client computers as long as at least one database server in the cluster has none of the above problems and can serve the database.

In order to operate the invention the following steps are performed:

1. The software that implements the invention is installed on the database servers that need to be clustered.

2. The servers are connected to a network, over a TCP/IP connection. Network security policies are configured so that the each clustered server can access the other clustered servers, and such that transactional replication links can be deployed.

3. The clustered database (or databases) is installed on one of the clustered servers (defined as the “Origin server”).

4. The Database Grid (DG) function is executed. The DG creates copies of the selected origin server's databases on the other servers in the cluster. Transactional replication links are established between the clustered databases.

5. The Master Election process is started and constantly determines which server is the active server.

6. The Cluster Commit function is called by the applications that drive transactions to the database (the ‘database application’). The Cluster Commit function guarantees that the current consistent state of the active node's version of the database is durable in all cluster nodes. The Cluster Commit function does not stall the operation of the database server.

7. In case of a failure in the active node, another server in the cluster becomes Active. This may result in a momentary loss of database connection for some or all of the applications that are connected to the clustered database. However, the application is typically able to recover from such a situation.

8. At this stage the database application can be started and transactions can be sent to the database cluster.

The principles and operation of a system and a method according to the present invention may be better understood with reference to the drawings and the accompanying description, it being understood that these drawings are given for illustrative purposes only and are not meant to be limiting, wherein:

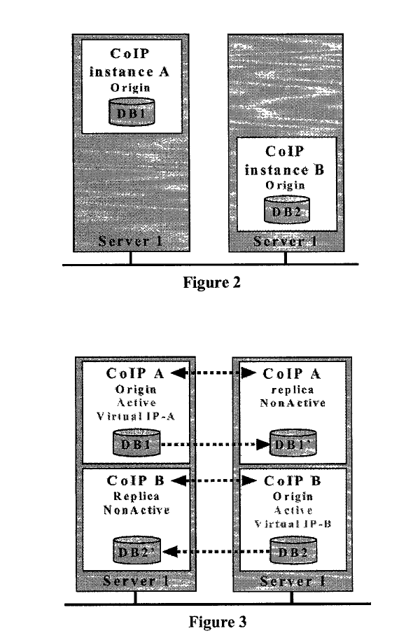

An example of the implementation of the Invention can be seen in FIGS. 2-7. The software of the present invention, as described above, is hereinafter referred to as “Cluster Over IP (CoIP)” software.

FIG. 2 shows a simple example of the initial state of CoIP cluster installation. A simple cluster configuration may consist of two servers, Server 1 and Server 2. The software of the present invention (CoIP) forms from these servers a distributed database cluster using transactional replication. The CoIP manages the servers and databases, directing traffic only to those databases that are correctly servicing application requests.

Initially, databases are installed on the Origin server (the active server) using standard procedures. At least one separate database (e.g. DB1,DB2) may be installed on each server, to gain enhanced performance. Databases may be installed prior to the installation of the CoIP or after. The CoIP is subsequently installed on each participating server.

The CoIP creates copies of the installed databases and creates the above-described database grid technology (see FIG. 3). CoIP keeps the databases continuously synchronized, using its database grid function (described above).

The Master election process constantly selects the “Active server”, i.e. the server in the cluster to which transactions will be assigned.

The administrator defines the CoIP instances and a virtual IP address for each instance (IP-A and IP-B for DB1 and DB2 in FIG. 3).

The database application is configured to connect to the related cluster Virtual IP addresses (Virtual IP-A for DB1 and Virtual IP-B for DB2 in FIG. 4).

Transactions committed using the cluster commit mechanism are fed by an instructing application into the active database (on the active cluster server).

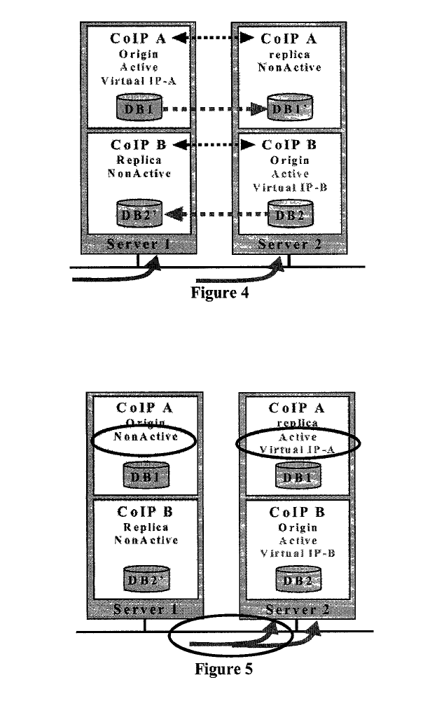

If a server or application failure is detected by the CoIP, the master election process selects another server in the cluster to become the active node, by assigning the relevant virtual IP address to the selected server. In the example provided in FIG. 5, server B assumes Virtual IP-A to overcome a failure in server A (black circles mark the changed items compared to normal operation).

Transactions that continue to be sent to the same virtual IP address now arrive at the new active server (server B in the example in FIG. 5).

Since all databases on the new active server are already synchronized, fail-over time is minimal. Transactions are logged and kept on the active server until the failed server recovers, thereby ensuring quick recovery, data coherency and no loss of data. These results are a function of the database grid and cluster commit techniques described above.

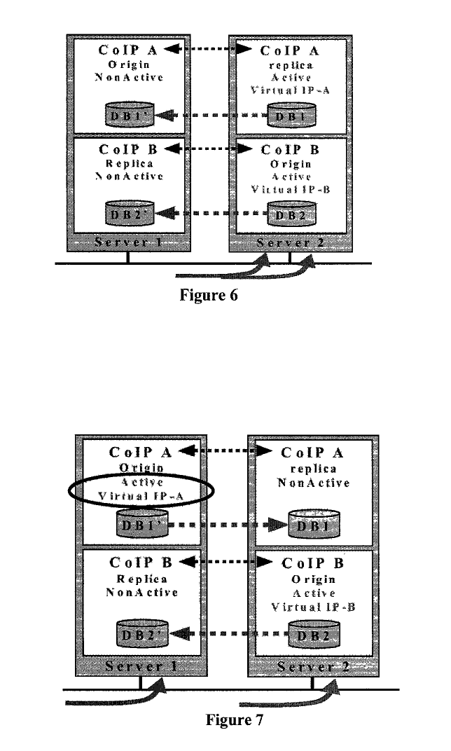

When the failed server recovers (the event is identified by the CoIP software), logged transactions on the current active server are sent to the databases in the recovering server (See FIG. 6).

Databases on the recovering server are synchronized to those on the active server. Transactions continue to arrive at the active server (server B in the example) until all databases on the origin server (server A in the example) are fully synchronized. The synchronization process is transparent to the user and the application, since the active server continuously handles transactions. Therefore, from the application's standpoint, the database is fully operational at any time during this process.

Once all databases are synchronized, the master election process may select a new active server (typically the Origin server), which assumes the relevant virtual IP address. FIG. 7 shows the last phase of the recovery process, wherein the Origin server once again becomes the active server.

According to an additional embodiment of the present invention, a method is provided for enabling effective load balancing within distributed database clusters. Load balancing refers to distributing the processing of database requests across the available servers. According to this embodiment, transactions involving modifications to the database are always processed by the active server. Furthermore, read-only transactions are either processed by the active server or directed to any of the inactive, available servers, for processing, using arbitrary decision riles. An example for such a rule is randomly selecting a server among currently available servers, which creates uniform load balancing of read requests. Other load-balancing schemes may be implemented using other decision rules. However any set of decision rules that are used must never select an unavailable server for processing read requests. As long as this constraint is preserved, read transactions will access consistent, up-to-date versions of the database at all times, since the Cluster Commit mechanism guarantees that committed transactions are present at all available server databases before the Cluster Commit operation successfully completes.

### ADVANTAGES OF THE INVENTION

Being a distributed database clustering technology, the present invention is superior to known shared-storage technologies, in that it has no single point of failure.

The inherent limitations of existing technologies make creation of distributed database clusters (i.e. such clusters that comply with transaction ACID properties) very expensive in some cases (multiple locations with high-bandwidth, low-latency interconnection) and impossible in others (multiple locations too far apart to provide the required latency). The present invention allows the creation of distributed database clusters with no latency constraints, allowing deployment of distributed clusters over virtually any network. This enables distributed configurations that are virtually impossible today, and lowers the cost for those that could be implemented using distributed storage techniques. Furthermore, distributed database clusters allow companies to protect their business-critical databases against all types of failures, such as server crashes, network failures or even when an entire site goes down.

The technology according to the present invention is the first known technology that utilizes asynchronous replication that complies with the durability requirement of database servers. An innovative technology is hereby provided for database clustering built on top of asynchronous replication. Furthermore, the technology of the present invention enables building an affordable database disaster protection system through the distributed database cluster.

Asynchronous replication systems and transactional durability are virtually contradicting constraints, and it is virtually impossible to achieve the combination of the two using existing technologies. The present invention provides a method for enabling an asynchronous replication system combined with transactional durability.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A method for distributed database clustering, comprising:
executing a Database Grid mechanism, using asynchronous transactional replication, for maintaining multiple copies of databases on a plurality of servers in a cluster;
executing a Cluster Commit mechanism, to maintain transaction durability; and
executing a master election component, to determine which cluster server is an active server.

2. The method of claim 1, wherein said Database Grid mechanism further comprises:
defining an origin database;
duplicating said origin database, thereby creating a matrix of databases that are exact copies of said origin database, said matrix of databases residing on a plurality of cluster servers;
creating a set of one-way asynchronous transactional replication links between said plurality of databases, to allow changes in an “active” database to propagate to all said databases in said matrix, said asynchronous replication links comprising static and local replications;
executing said static replications continuously, to copy pending transactions through said replication links;
executing dynamic maintenance of said local replications to accurately reflect active server changes; and
synchronizing said plurality of databases.

3. The method of claim 2, further comprising adapting said local replications to accurately reflect requirements of said active database.

4. The method of claim 1, wherein said Cluster Commit operation further comprises the steps of:
executing an availability monitor mechanism on an active server, thereby continuously updating a list of Available servers;
executing a cluster commit operation, following instructions from an application, said cluster commit operation comprising:
i. adding a table for each database in the database cluster;
ii. adding a database version number to each said table;
iii. executing an application command, thereby incrementing said version number on said active server; and
iv. waiting for said transaction to be committed at all Available Servers while marking as “Unavailable” all servers not responding within a determined period, such that said “Unavailable” servers are removed from the list of servers for which said cluster commit operation waits.

5. The method for claim 4, wherein said active database server may continue processing transactions normally while said cluster commit operation is in progress.

6. The method of claim 4, further comprising:
entering a Cold-Start state whenever a cluster server suffers a failure that does not allow said server to continue receiving database updates from other servers in said cluster, to collect more information for deciding which server should be defined as the active cluster server; and
exiting said cold-start state, by receiving a periodic message from said active cluster server.

7. The method of claim 6, wherein exiting of said cold-start state further comprises, in the case where no active server exists:
waiting, by said server, to receive messages from all cluster servers, in order to determine which has the latest database version; and
selecting said database with said latest database version as a candidate to be a new active server.

8. The method of claim 1, wherein said Cluster Commit operation enables distributed database-clustering, without being inherently restricted by the distance between cluster servers.

9. The method of claim 1, wherein said master election component is executed according to the following steps:
deciding on a continual basis which server is an active server candidate;
if said candidate is different from current active server, executing a fail-over process, wherein said current active server relinquishes its active state; and
executing a take-over procedure, wherein said candidate is established as a new active server.

10. The method of claim 8, wherein said execution of a master election component furthermore complies with the constraints selected from the group consisting of:
a server with an error condition preventing said server from communicating with a network backbone is never selected to be an active server candidate;
an unavailable server is never selected to be said active server candidate; and
a cold-starting server is not selected to be said active node candidate, unless all other cluster servers are similarly in a cold start state and said server has the latest version of said database.

11. The method of claim 1, wherein said distributed database clustering meets the requirements selected from the group consisting of: no single point of failure; guaranteeing data consistency; complying with transaction ACID properties; automatically recovering from subsequent failures; and causing no inherent performance degradation of said cluster server.

12. A database clustering method for enabling high availability of data, while maintaining transaction durability, comprising:
i. installing computer executable code for implementing the clustering method on a plurality of database servers, for clustering said servers;
ii. connecting said servers to a network, said network enabling each said server to access other said servers, and such that transactional replication links can be deployed between said servers;
iii. installing one clustered database on one of said clustered servers, said clustered server being an “Origin server”;
iv. executing a database grid function, thereby maintaining copies of said origin server's at least one database on said other servers;
v. starting a Master Election process to select an active server; and
vi. calling a cluster commit function, by an application, to guarantee that a current consistent state of said active server's version of said database is durable in all cluster servers.

13. The method of claim 12, further comprising, in case of a failure in said active server, activating another server to be a new active server in said cluster.

14. The method of claim 12, wherein said steps iii-vi. are repeated for clustering of at least one additional database.

15. A method for enabling load balancing within distributed database clusters, comprising:
processing write-only transactions by an active server in the cluster; and
processing read-only transactions by any available server in the cluster.

16. The method of claim 15, wherein said read-only transactions are served by any available servers, using decision rules.
